(19) United States
(12) Patent Application Publication
(10) Pub. No.: US 2021/0383218 A1
(43) Pub. Date: Dec. 9, 2021

(54) DETERMINING CONTROL POLICIES BY MINIMIZING THE IMPACT OF DELUSION

(71) Applicant: Google LLC, Mountain View, CA (US)

(72) Inventors: Tian Lu, Mountain View, CA (US); Dale Eric Schuurmans, Mountain View, CA (US); Craig Edgar Boutilier, Palo Alto, CA (US)

(21) Appl. No.: 17/289,514

(22) PCT Filed: Oct. 29, 2019
(86) PCT No.: PCT/US2019/058660

§ 371 Date: Apr. 28, 2021

Related U.S. Application Data
(60) Provisional application No. 62/752,306, filed on Oct. 29, 2018.

(51) Int. Cl. G06N 3/08

(52) U.S. Cl. CPC G06N 3/08

(57) ABSTRACT

Methods, systems, and apparatus, including computer programs encoded on computer storage media, for determining a control policy for an agent interacting with an environment. One of the methods includes updating the control policy using policy-consistent backups using Q learning. To determine a policy-consistent backup, the system determining a policy-consistent backup for the control policy at the current observation—current action pair, comprising: for each of a plurality of actions in a set of possible actions that can be performed by the agent, identifying Q values assigned by the control policy to next observation—action pairs by the control policy and justified by at least one of the information sets; pruning, from the identified Q values, any Q values that are justified only by information sets that are not policy-class consistent; and determining, from the reward and only the identified Q values that were not pruned, the policy-consistent backup.

### CROSS-REFERENCE TO RELATED APPLICATION

This application claims the benefit of priority to U.S. Application Ser. No. 62/752,306, filed on Oct. 29, 2018, the entirety of which is herein incorporated by reference.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that controls an agent interacting with an environment and, in particular, that determines a control policy for use in controlling the agent.

Particular embodiments of the subject matter described in this specification can be implemented so as to realize one or more of the following advantages.

Conventional systems that use Q-learning to learn a control policy for an agent can update the policy using backed-up value estimates that are derived from action choices that are not realizable in the underlying policy class. That is, in conventional Q-learning, a back up for a state-action pair is generated by independently choosing actions at the corresponding next state using a max operator, i.e., by generating a target Q value by using the Q value for the argmax action when selected at the next state. This assumes that the independently chosen maximum value is feasible, i.e., that choosing the action that results in the maximum Q value at the next state is consistent with the other action choices taken to arrive at the next state. In other words, this assumes that there is a control policy that would both select the action that results in the maximum Q value at the next state and make the other action choices taken to arrive at the next state.

When this assumption is violated, as it frequently can be, this causes problems for the control policy learning process. In particular, violating these assumptions (as occurs in systems that implement conventional variants of Q-learning) can result in the learning process diverging, can cause a control policy to be learned that does not perform well on the task, or cause the learning process to run for an excessive amount of iterations. The described techniques, on the other hand, avoid violating this assumption or minimize violations of this assumption, resulting in improved control policies being learned for agents, which, in turn, improves the performance of the agent on the desired task. Additionally, control policies can be learned in fewer iterations, reducing the computational resources consumed by the learning process.

In particular, the described techniques determine updates (and back-ups) to the control policy using a variety of techniques that either avoid violating this assumption explicitly, e.g., by maintaining information sets and only updating these information sets with policy consistent Q values, or by employing heuristics that reduce the likelihood of the assumptions being violated, e.g., by selecting next actions that are locally consistent within a batch of training tuples.

When used in conjunction with a real-world environment and agent, such as a mechanical agent/robot or a plant/service facility, the described techniques can result in improvements in the control policies learned for controlling said agents, for example improvements in the energy efficiency, accuracy, speed and/or output of a task performed using the learned control policy.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example reinforcement learning system.

FIG. 1B shows an example environment that is susceptible to “delusional bias.”

FIG. 2 is a flow diagram of an example process for learning a control policy using Q learning with policy-consistent backups.

FIG. 3 is a flow diagram of an example process for learning a control policy using value iteration with policy-consistent backups.

FIG. 4 is a flow diagram of an example process for learning a control policy using locally consistent backups.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent.

At each time step, the state of the environment at the time step depends on the state of the environment at the previous time step and the action performed by the agent at the previous time step.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., one or more of: images, object position data, and sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the mechanical agent/robot, e.g., torques for the joints of the robot or higher-level control commands, or the autonomous or semi-autonomous land, air, sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g., braking and/or acceleration of the vehicle.

In the case of an electronic agent the observations may include data from one or more sensors monitoring part of a plant or service facility such as current, voltage, power, temperature and other sensors and/or electronic signals representing the functioning of electronic and/or mechanical items of equipment. For example the real-world environment may be a manufacturing plant or service facility, the observations may relate to operation of the plant or facility, for example to resource usage such as power consumption, and the agent may control actions or operations in the plant/facility, for example to reduce resource usage. In some other implementations the real-world environment may be a renewal energy plant, the observations may relate to operation of the plant, for example to maximize present or future planned electrical power generation, and the agent may control actions or operations in the plant to achieve this.

In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/service facility, and/or actions that result in changes to settings in the operation of the plant/service facility e.g. to adjust or turn on/off components of the plant/facility.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some implementations the environment may be a simulated environment and the agent may be implemented as one or more computers interacting with the simulated environment.

The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

In some implementations, the simulated environment may be a simulation of a particular real-world environment. For example, the system may be used to select actions in the simulated environment during training or evaluation of the control neural network and, after training or evaluation or both are complete, may be deployed for controlling a real-world agent in the real-world environment that is simulated by the simulated environment. This can avoid unnecessary wear and tear on and damage to the real-world environment or real-world agent and can allow the control neural network to be trained and evaluated on situations that occur rarely or are difficult to re-create in the real-world environment.

Generally, in the case of a simulated environment, the observations may include simulated versions of one or more of the previously described observations or types of observations and the actions may include simulated versions of one or more of the previously described actions or types of actions.

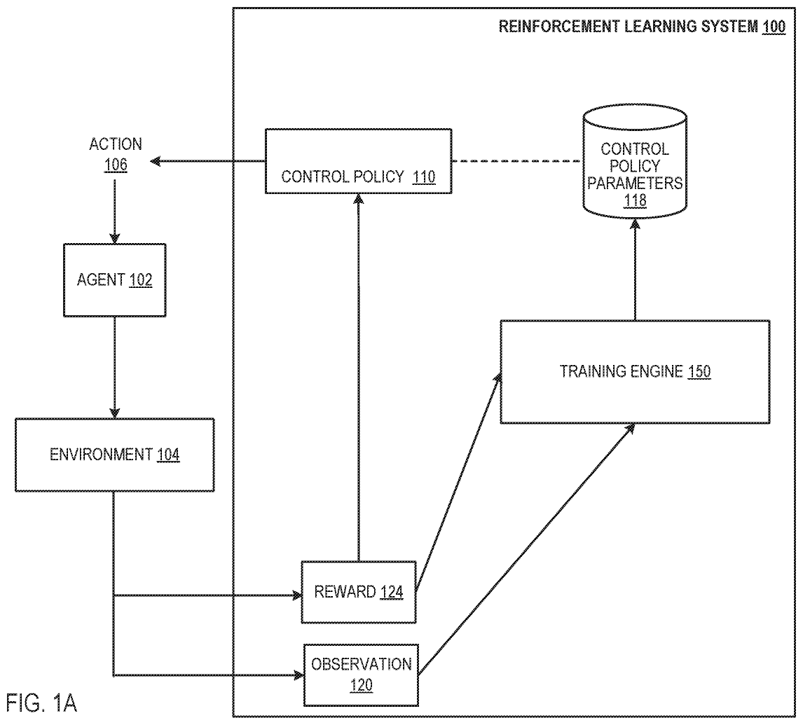

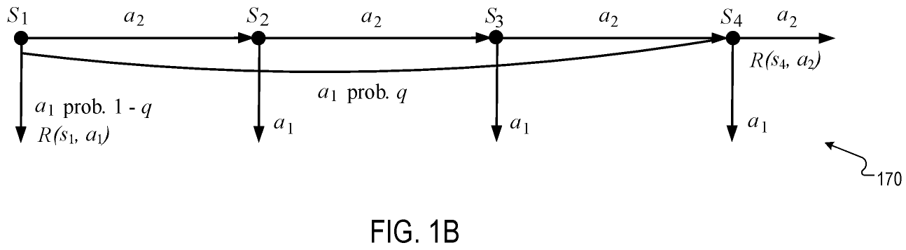

FIG. 1A shows an example reinforcement learning system 100. The reinforcement learning system 100 is an example of a system implemented as computer programs on one or more computers in one or more locations in which the systems, components, and techniques described below are implemented.

The system 100 controls an agent 102 interacting with an environment 104 by selecting actions 106 to be performed by the agent 102 and then causing the agent 102 to perform the selected actions 106.

Performance of the selected actions 106 by the agent 102 generally causes the environment 104 to transition into new states. By repeatedly causing the agent 102 to act in the environment 104, the system 100 can control the agent 102 to complete a specified task.

The system 100 includes a control policy 110, a training engine 150, and one or more memories storing a set of control policy parameters 118 of the control policy 110. At each of multiple time steps, the control policy 110 maps the current observation 120 characterizing the current state of the environment 104 to an action 106 in accordance with the control policy parameters 118 to generate an action selection output 122.

In particular, the control policy 110 generates a respective Q value for each action in the set of actions and then selects one of the actions. The Q value for an action is an estimate of a “return” that would result from the agent performing the action in response to the current observation 120 and thereafter selecting future actions performed by the agent 102 in accordance with a greedy control policy that selects the action having the highest Q value in response to each observation, i.e., where the Q values are generated in accordance with the control policy parameters 118.

A return refers to a cumulative measure of “rewards” 124 received by the agent, for example, a sum of rewards or a time-discounted sum of rewards. The agent can receive a respective reward 124 at each time step, where the reward 124 is specified by a scalar numerical value and characterizes, e.g., a progress of the agent towards completing an assigned task.

For example, during training, the control policy 110 can select the action to be performed by the agent in accordance with an exploration policy. For example, the exploration policy may be an ϵ-greedy exploration policy, where the system 100 selects the action having the highest Q value with probability 1-ϵ, and randomly selects the action with probability E. In this example, E is a scalar value between 0 and 1.

After training, the control policy 110 can employ a greedy action selection policy, i.e., by always selecting the action with the highest Q value.

The system 100 then controls the agent, i.e., by causing the agent to perform the action 106 selected by the control policy 110.

The control policy 110 can map observations to Q values using any of a variety of techniques.

As one example, the control policy 110 can maintain a tabular representation of a Q function that maps (observation, action) pairs to Q values. In this example, during training, the system 100 directly updates the Q values in the tabular representation, i.e., the control policy parameters are the Q values in the tabular representation.

As another example, the control policy 110 can maintain a function approximator that approximates the Q function. The function approximator can be, e.g., a neural network (also referred to as a Q neural network) when the observations include high-dimensional data, e.g., images of the environment. Alternatively, the function approximator can be a linear model or a generalized linear model. In these cases, during training, the system 100 learns values of the parameters of the function approximator, i.e., the control policy parameters are the parameters of the function approximator. The training engine 150 is configured to train the control policy 110 by repeatedly updating the control policy parameters 118 of the control policy 110, i.e., the parameters of the function approximator or the Q values in the tabular representation.

In particular, the training engine 150 trains the control policy 110 using reinforcement learning using observations 120 and rewards 124 generated as a result of the agent interacting with the environment during training.

Generally, the training engine 150 can train the control policy 110 to increase the return (i.e., cumulative measure of reward) received by the agent using Q updating, e.g., using either Q learning or value iteration.

In other words, the training engine 150 uses observations 120, actions performed in response to those observations, and rewards 124 to repeatedly update the control policy parameters 118.

The training engine 150 updates the control policy parameters 118 in a manner that eliminates or mitigates the impact of “delusional bias” on the learning of the control policy parameters 118. In particular, “delusional bias” occurs whenever a backed-up value estimate is derived from action choices that are not realizable in the underlying policy class. In other words, if no policy in the admissible class can jointly express all past (implicit) action selections, backed-up values do not correspond to Q-values that can be achieved by any expressible policy.

FIG. 1B illustrates an environment 170 that is susceptible to “delusional bias.”

In the environment of FIG. 1B, episodes, i.e., series of interactions during which the agent attempts to perform a specified task, start at state s₁ and there are two actions: a₁ causes termination of the episode, except at s₁ where, if a₁ is performed, the environment can move to state s₄ with probability q. The other action, a₂, moves the environment deterministically to the next state in the sequence s₁ to s₄ with episode termination occurring when a₂ is performed at s₄. The rewards for performing actions are 0 except that there is a positive, non-zero reward R (s₁, a₁) when a₁ is performed at s₁ and another positive, non-zero reward R(s₄, a₂) when a₂ is performed at s₄.

For concreteness, let q=0.1, R (s₁, a₁)=0.3, and R(s₄, a₂)=2.

Now, consider a linear function approximator ƒ_{θ} that operates on features of state action pairs, i.e., the observations are a feature value for the state, and the inputs to the approximator are the feature value for the state and a feature value for the action, and that generates Q values for the state action pairs. In particular, the linear function approximator operates on a two-dimensional feature vector, with the first dimension being a feature of the state and the second dimension being a feature of the action, i.e., state-action features φ(s, a). Thus, the linear function approximator is of the form ƒ_{θ}φ(s, a)=θ₁φ(s)+θ₂φ(a), where θ₁ and θ₂ are the parameters of the approximator that are learned through Q updating, e.g., either through Q learning or value iteration.

In the particular example of FIG. 1B, the two state-action features are as follows: φ(s₁, a₁)=φ(s₄, a₁)=(0, 1); φ(s₁, a₂)=φ(s₂, a₂)=(0.8, 0); φ(s₃, a₂)=φ(s₄, a₂)=(−1, 0); and φ(s₂, a₁)=φ(s₃, a₁)=(0, 0).

Given this, the linear function approximator cannot both (i) map φ(s₂, a₂)=(0.8, 0) to a higher Q value than φ(s₂, a₁)=(0,0) and (ii) map φ(s₃, a₂)=(−1, 0) to a higher Q value than φ(s₃, a₁)=(0, 0). That is, no combination of values for θ₁ and θ₂ could yield an approximator that satisfies both (i) and (ii).

Thus, no greedy action selection policy π can satisfy both π(s₂)=a₂ and π(s₃)=a₂, i.e., there is no policy under which the system can pick the action a₂ when in state s₂ and pick action a₂ when in state s₃. In other words, because the greedy policy picks the action with the highest Q value, any greedy policy that would pick the action a₂ when in state s₂ would pick action a₁ when in state s₃ and any greedy policy that would pick action a₂ when in state s₃ would pick the action a₁ when in state s₂. Hence, the optimal unconstrained policy (take a₂ everywhere, with expected value 2) is not realizable. Q-updating can therefore never converge to the unconstrained optimal policy. Instead, the optimal achievable policy would take a₁ at s₁ and a₂ at s₄, achieving a value of 0.5.

Conventional Q-updating is unable to find the optimal admissible policy π in this example. For example, online Q-learning with data generated using an ε-greedy behavior policy (ε=0.5) converges to a fixed point that gives a “compromised” admissible policy which takes a₁ at both s₁ and s₄ (with a value of 0.3).

This example shows how delusional bias prevents Q-learning from reaching a reasonable fixed-point.

For example, consider the backups at (s₂, a₂) and (s₃, a₂). Suppose the current function approximator assigns a “high” value to (s₃, a₂) (i.e., so that the Q value for (s₃, a₂) is greater than the Q value for (s₃, a₁)) as would be required for the optimal control policy.

Intuitively, this requires that θ₁ be less than 0, and generates a “high” bootstrapped value for (s₂, a₂). But any update to θ₁ and θ₂ that tries to fit this value (i.e., makes the Q value of (s₂, a₂) be greater than the Q value of (s₂, a₁)) forces θ₁ to be greater than 0, which is inconsistent with the assumption (that θ₁<0) needed to generate the high bootstrapped value. In other words, any update that moves the Q value for (s₂, a₂) higher undercuts the justification for it to be higher.

The result is that the Q-updates compete with each other, with the Q value for (s₂, a₂) converging to a compromise value that is not realizable by any possible policy. This is because the backups generated by conventional Q learning are independent of previous actions and do not consider whether the action required to generate the backup is consistent with previous actions.

By modifying how backups are generated, e.g., for Q-learning or value iteration, the described systems can achieve better performance than conventional updating techniques, i.e., can generate control policies that compile returns that are closer to the optimal return than control policies generated using conventional techniques and, therefore, result in the agent performing better on the specified task.

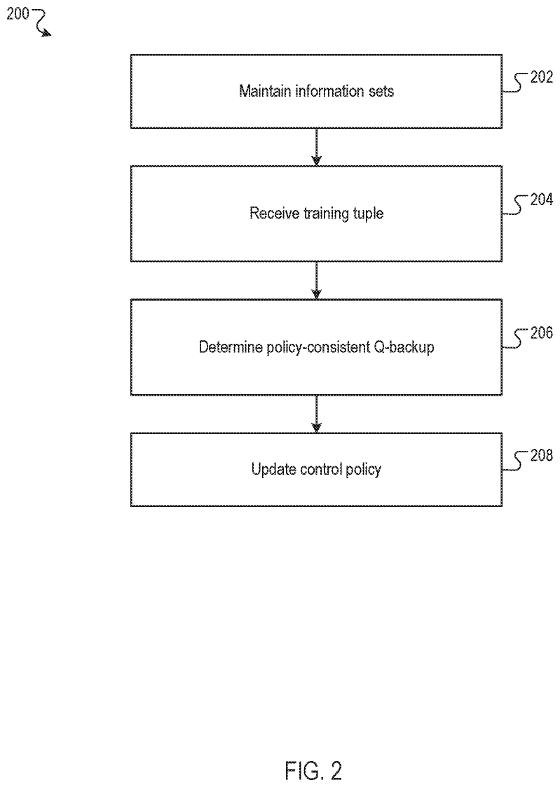

In some cases, the system maintains information sets and uses the information sets when determining backups for Q learning. That is, the system updates the control policy using model-free Q learning. This process is described in more detail below with reference to FIG. 2.

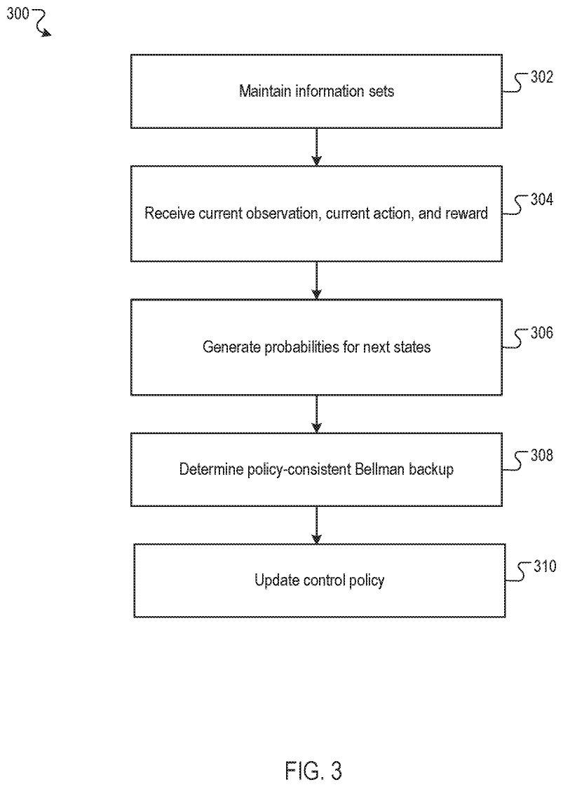

In some other cases, the system maintains a transition model that models the dynamics of the environment. The transition model maps observation—action pairs to probabilities for each of multiple next states. The probability for a next state represents the likelihood that the next state will be the state that the environment transitions into when the agent performs the action in the pair in response to the observation in the pair. The system can use this transition model and the maintained information sets to determine backups using value iteration. This process is described in more detail below with reference to FIG. 3.

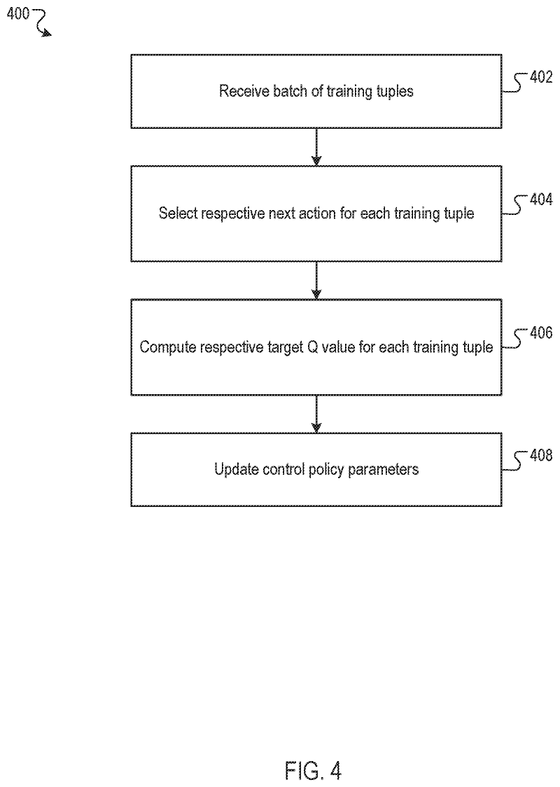

In yet other cases, the system does not maintain multiple information sets and instead ensures that backups are computed using locally consistent Q values when performing batch Q learning. This process is described in more detail below with reference to FIG. 4.

FIG. 2 is a flow diagram of an example process 200 for learning a control policy using Q learning with policy-consistent backups. For convenience, the process 200 will be described as being performed by a system of one or more computers located in one or more locations. For example, a reinforcement learning system, e.g., the reinforcement learning system 100 of FIG. 1, appropriately programmed, can perform the process 200.

The system can repeatedly perform the process 200 to update the control policy, i.e., to repeatedly update the control policy parameters.

The system maintains data defining one or more information sets (step 202). Each information set corresponds to a respective set of policy constraints and identifies Q values assigned to observation—action pairs by the control policy under the set of policy constraints.

In cases where the policy uses a tabular representation, the system can maintain a separate table of Q values for each information set.

In cases where the policy uses a function approximator, the system can maintain a separate function approximator for each information set (or, equivalently, an independent set of parameters or weights of the same function approximator for each information set).

Each set of policy constraints generally corresponds to some set of action—observation pairs and specifies that the policy must be able to, for all the corresponding action—observation pairs, select the action in the pair in response to the observation in the pair. In other words, each set of policy constraints specifies one or more paths through the environment that must be able to be realized by the policy. As a particular example, in the example of FIG. 1B, one information set may constrain the policy to those policies that can select the action a₁ at state s₁ and the action a₂ at state s₄, another information set may constrain the policy to those policies that can select the action a₁ at state s₁ and the action a₁ at state s₄, and another information set may constrain the policy to those policies that can select the action a₂ at state s₁ and the action a₂ at state s₂.

In some cases, however, the pairs corresponding to any given set of policy constraints can also be based on constraints on operation of the agent that impact what actions can be selected in a given environment state, e.g., safety constraints or other operational constraints.

In particular, let Θ be the parameter class defining Q-functions. An information set X⊆Θ is a set of policy constraints that justify assigning a particular Q-value q to some (s, a) pair.

Information sets can generally be viewed as finite partitions of Θ, i.e., a set of non-empty subsets P={X1, . . . , Xk} such that X1 ∪ . . . ∪Xk=Θ and Xi ∩Xj=Ø, for all i≠j.

Additionally, a partition P′ is a refinement of P if for all X′∈P′ there exists an X ∈P such that X′⊆X.

The system receives a current observation characterizing a current state of the environment, a current action performed by the agent in response to the current observation, a next observation characterizing a next state of the environment, and a reward received as a result of the agent performing the current action (step 204).

In other words, the system receives a training tuple for use in determining an update to the control policy. In some cases, e.g., when the updates are being computed on-policy, the action was selected in accordance with the current values of the policy parameters. In other cases, e.g., when the updates are being computed off-policy, the training tuple was sampled from a replay memory and the action may have been selected using different, older values of the policy parameters.

The system determines a policy-consistent Q-backup for the control policy at the current observation s—current action a pair (step 206).

In particular, for each of the plurality of actions in the set of possible actions that can be performed by the agent, the system identifies Q values that are assigned by the control policy to next observation—action pairs and that are justified by at least one of the information sets. A Q value is justified by an information set when the control policy would have assigned the Q value to the next observation—action pair when operating under the constraints imposed by the information set.

The system then prunes, from the identified Q values, any Q values that are justified only by information sets that are not policy-class consistent. An information set is not policy-class consistent when a greedy policy operating under the constraints imposed by the information set would not have selected the current action in response to the current observation. Thus, any Q values that are justified only by information sets that would not have resulted in the current action being performed in response to the current observation are pruned from the set of identified Q values.

The system then determines, from the reward and only the identified Q values that were not pruned, the policy-consistent backup. In particular, the policy-consistent backup includes a backup, i.e., target output, for each information set that justifies a Q value that was not pruned. In particular, for a given one of these information sets, the update can be based on the reward in the tuple and the identified Q value that is justified by the information, e.g., a sum of (i) the reward and (ii) the product of a discount factor and the identified Q value.

The system updates the control policy for the agent using the policy-consistent backup using Q learning (step 208). In particular, the system can update each of the information sets that justifies a Q value that was not pruned using the update for the information set.

When the system uses a tabular representation of the Q function, the system can update the Q value for each of the information set by computing a weighted sum of the current Q value and the backup for the information set.

When the system uses a function approximator to approximate the Q function, the system can compute an update to the function approximator corresponding to the information set by computing a supervised learning update that is based on a gradient of an error between the current Q value and the backup for the information set, e.g., a mean-squared error.

Thus, as can be seen from the description of FIG. 2, the system does not identify an argmax action independently when computing the backup (as is done in conventional Q-updating) and instead maintains information sets and updates each only using Q values that are consistent with that information set.

Because information sets impose policy constraints and therefore the number of information sets grows as the agent explores the environment, the total number of information sets can grow large in complex environment. In some implementations, the system can prune information sets during the training, merge information sets during the training, or both when certain criteria are satisfied. For example, when the number of information sets exceeds a threshold number, the system can prune information sets that have the lowest Q values or can combine information sets that have the lowest Q values.

Once training has completed, the system can select the policy parameters represented by one of the information sets as the final set of policy parameters. In particular, the system can select the policy parameters that result in the highest Q value being assigned to the action that is selected by the control policy in an initial state of any given episode of controlling the agent as the policy parameters that will be employed in controlling the agent for the episode.

Table 1, below, shows pseudo-code for learning a control policy using the process 200 when the system uses a tabular representation of the Q function. In particular, in Table 1, the notation is as follows:
(s, a, r, s′) is a training tuple,
Q[sa] is a table such that Q[sa](X) is the Q-value of taking action a at s and then following a greedy policy parameterized by θ ∈X, where the parameters θ represent the constraints imposed by the information set X
ConQ[sa] is a table such that ConQ[sa](X) is the Q-value of taking action a at s and then following a greedy policy parameterized by θ∈X, with the additional constraint that π_{θ}(s)=a. That is, that the greedy policy when parameterized by the parameters θ must select the action a at state s for the Q-value of taking action a at s to appear in the table ConQ[sa],
ConQ[s] is a table formed from concatenating tables ConQ[sa] for all a at s,
s→a is the set of policy parameters such that the greedy policy selects the action a at state s,
⊕ is the intersection sum and is defined such that h=h₁⊕h₂ is defined by
   h(X₁∩X₂)=h₁ (X₁)+h₂ (X₂), ∀X₁∈ dom(h₁), X₂∈ dom(h₂), X₁∩X₂≠Ø, and
dom(⋅) is the domain of a function.

TABLE 1

| Input: | Batch B = {(sₜ, aₜ, rₜ, s [symbol] )} [symbol] [symbol] , ⊖, scalars [symbol] |
|---|---|
| 1: | for (s, a, r, s [symbol] ) ϵ B, t is iteration counter do |
| 2: | For all a′, if s′ a′ ϵ ConQ then initialize |
| | ConQ[s′a′] ← ([ s′ [symbol] a′] [symbol] 0). |
| 3: | Update ConQ[s^{t}] by combining ConQ[s^{t}a^{t}](X), for all a′, |
| | X ϵ dom(ConQ[s′ a′]) |
| 4: | Q[sa] ← (1−a [symbol] )Q[sa] ⊕ [symbol] (r + [symbol] ConQ[s′]) |
| 5: | ConQ[sa](Z) ← Q[sa](X) for all X such that Z = X ∩ [s [symbol] a] |
| | is non-empty |
| 6: | end for |
| 7: | Return ConQ, Q |

[symbol]

indicates data missing or illegible when filed

FIG. 3 is a flow diagram of an example process 300 for learning a control policy using value iteration with policy-consistent backups. For convenience, the process 300 will be described as being performed by a system of one or more computers located in one or more locations. For example, a reinforcement learning system, e.g., the reinforcement learning system 100 of FIG. 1, appropriately programmed, can perform the process 300.

As above, the system maintains one or more information sets (step 302).

The system obtains a current observation, and action performed in response to the observation, and a reward (step 304).

The system determines a respective probability for each of a plurality of next states using a transition model (step 306).

In particular, the system uses the transition model that models the dynamics of the environment to predict a respective probability for each of a plurality of next states that represents the likelihood that the next state is the state that the environment transitions into as a result of the agent performing the action in response to the current observation.

The system determines a policy-consistent Bellman backup for the control policy at the current observation s—current action a pair (step 308).

Generally, the system performs the following independently for each next state that is assigned a non-zero probability by the transition model to generate a set of Q values for the next state and then combines the results to generate the policy-consistent Bellman backup for the control policy.

In particular, for each of the plurality of actions in the set of possible actions that can be performed by the agent and for any given next state, the system identifies Q values that are assigned by the control policy to next observation—action pairs and that are justified by at least one of the information sets (where the “next observation” is one that characterizes the given next state).

The system then generates a set of Q values for the next state by pruning, from the identified Q values, any Q values that are justified only by information sets that are not policy-class consistent. Thus, any Q values that are justified only by information sets that would not have resulted in the current action being performed in response to the current observation are pruned from the set of identified Q values for the next state.

The policy-consistent backup includes a backup, i.e., target output, for each information set that justifies a Q value that was not pruned for any of the next states. In particular, for a given one of these information sets, the update can be based on the reward in the tuple and, for each next state in which the given information set justified a Q value that was not pruned, the Q value that is justified by the information set and the probability assigned to the next state. For example, to compute the backup for the given information set, the system can compute, for each next state, a product of the probability assigned to the next state and the Q value that is justified by the information set for the next state and then sum these products to determine an initial update. The system can then compute the backup for the information set as a sum of (i) the reward and (ii) the product of a discount factor and the initial backup for the next state.

The system updates the control policy for the agent using the policy-consistent backup using Q learning (step 310). In particular, the system can update each of the information sets that justifies a Q value that was not pruned using the update for the information set. In some cases, the system also updates the information sets that do not justify any Q value that was not pruned, e.g., using only the reward.

When the system uses a tabular representation of the Q function, the system can update the Q value for each of the information sets by computing a weighted sum of the current Q value and the backup for the information set.

When the system uses a function approximator to approximate the Q function, the system can compute an update to the function approximator corresponding to the information set by computing a supervised learning update that is based on a gradient of an error between the current Q value and the backup for the information set, e.g., a mean-squared error.

As described above, in some implementations, the system can prune information sets during the training, merge information sets during the training, or both when certain criteria are satisfied. For example, when the number of information sets exceeds a threshold number, the system can prune information sets that have the lowest Q values or can combine information sets that have the lowest Q values.

Once training has completed, the system can select the policy parameters represented by one of the information sets as the final set of policy parameters. In particular, the system can select the policy parameters that result in the highest Q value being assigned to the action that is selected by the control policy in an initial state of any given episode of controlling the agent as the policy parameters that will be employed in controlling the agent for the episode.

Table 2, below, shows pseudo-code for learning a control policy using the process 300 when the system uses a tabular representation of the Q function. The notation used in Table 2 is the same as that used in Table 1, above, with the addition of:
p(s′|s,a) being the probability assigned to the next state s′ by the transition model, i.e., the probability that the next state s′ is the state that the environment transitions into as a result of the agent performing the current action a at the current state s.

TABLE 2

| Input: | S, A. p(s′ \| s, a), R, [symbol] , ⊖, initial state s₀ |
|---|---|
| 1: | Q[sa] ← initialize to mapping ⊖ [symbol] 0 for all s, a |
| 2: | ConQ[sa] ← initialize to mapping [s [symbol] a] [symbol] 0 for all s, a |
| 3: | Update ConQ[s] for all s (i.e., combine all table entries in |
| | ConQ[saₗ], . . ., ConQ[sa [symbol] ]) |
| 4: | repeat |
| 5: | for all s, a do |
| 6: | Q[sa] ← R [symbol] + [symbol] ⊕ₛ, p(s′ \| s, a)ConQ[s′] |
| 7: | ConQ[sa](Z) ← Q[sa](X) for all X such that Z = X ∩ [s [symbol] a] |
| | ia non-empty |
| 8: | Update ConQ[s] by combining table entries of ConQ[sa′] for |
| | all a′ |
| 9: | end for |
| 10: | until Q converges: dom(Q(sa)) and Q(sa)(X) does not change |
| | all s, a, X |
| 11: | /* Then recover an optimal policy */ |
| 12: | X* ← argmax_{X} ConQ[s₀](X) |
| 13: | q* ← ConQ[s₀](X*) |
| 14: | [symbol] * Witness(X*) |
| 15: | return [symbol] and q*. |

[symbol]

indicates data missing or illegible when filed

In both the process 200 and the process 300, the system maintains information sets. When the action space is large, the space of possible constraints (or possible policy parameters) is large, or the amount of computational resources available for performing the training process is limited, the system may refrain from employing multiple information sets and instead employ a single function approximator that is used to evaluate observation—action pairs. In these cases, the system may use updates that enforce local consistency to mitigate the impact of delusional bias on the training process.

FIG. 4 is a flow diagram of an example process 400 for learning a control policy using locally consistent backups. For convenience, the process 400 will be described as being performed by a system of one or more computers located in one or more locations. For example, a reinforcement learning system, e.g., the reinforcement learning system 100 of FIG. 1, appropriately programmed, can perform the process 400.

The system receives a batch of training tuples (step 402). As above, each training tuple includes a current observation characterizing a current state of the environment, a current action performed by the agent in response to the current observation, a next observation characterizing a next state of the environment, and a reward received as a result of the agent performing the current action.

The system selects a respective next action for each next observation in the batch (step 404). In particular, the system selects the respective next actions such that the next actions are locally consistent. More specifically, rather than selecting the argmax action for each next observation independently as in conventional Q learning, the system selects the next actions subject to criteria that ensure that the next actions are locally consistent with one another. The criteria specify that (i) all of the next actions can be selected using the same control policy, i.e., that there exists some set of policy parameters under which the control policy would select all of the next actions in response to their corresponding next observation and (ii) each next action must be consistent with the current action in the same tuple, i.e., that there exists some set of policy parameters under which the control policy would select the current action in response to the current observation and the next action in response to the next observation. In other words, for each next observation, the system selects as the next action the argmax action when only actions that satisfy both criterion (i) and criterion (ii) are considered, i.e., and any actions that do not satisfy (i), (ii), or both are disregarded.

The system computes a respective target Q value for each of the training tuples in the batch (step 406). In particular, the system determines a target Q value for each tuple from the reward in the tuple and the Q value generated by the control policy for the next observation—next action pair and then determines the update based on the target Q value, where the next observation is the next observation in the tuple and the next action is the next action selected for the tuple in step 404. For example, the target Q value can be the sum of the reward and the product of a discount factor and the Q value generated by the control policy for the next observation—next action pair.

The system updates the control policy parameters using the target Q values for the training tuples (step 408). In particular, the system computes a supervised learning update that is based on a gradient of an error between, for each tuple, the current Q value, i.e., the Q value currently generated by the function approximator for the current observation—current action pair and the target Q value for the tuple, e.g., a mean-squared error.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of determining a control policy for an agent interacting with an environment, the method comprising:
maintaining data defining a plurality of information sets, each information set corresponding to a respective set of policy constraints and identifying Q values assigned to observation—action pairs by the control policy under the set of policy constraints;
receiving a current observation characterizing a current state of the environment, a current action performed by the agent in response to the current observation, a next observation characterizing a next state of the environment, and a reward received as a result of the agent performing the current action;
determining a policy-consistent backup for the control policy at the current observation—current action pair, comprising:
for each of a plurality of actions in a set of possible actions that can be performed by the agent, identifying Q values assigned by the control policy to next observation—action pairs by the control policy and justified by at least one of the information sets;
pruning, from the identified Q values, any Q values that are justified only by information sets that are not policy-class consistent; and
determining, from the reward and only the identified Q values that were not pruned, the policy-consistent backup; and
updating the control policy for the agent using the policy-consistent backup using Q learning.

2. The method of claim 1, wherein updating the control policy for the agent using the policy-consistent backup using Q learning comprises updating the control policy using model-free Q learning, and wherein determining, from the reward and only the identified Q values that were not pruned, the policy-consistent backup comprises determining a Q-backup.

3. The method of claim 1, wherein the policy-consistent backup includes a respective backup for each information set that justifies a Q value that was not pruned.

4. The method of claim 3, wherein the respective backup is based on (i) the reward and (ii) the Q value that was not pruned and that is justified by the information set.

5. The method of claim 1, wherein information sets that are not policy-class consistent are those information sets that impose policy constraints that result in the control policy not selecting the current action in response to the current observation.

6. A method of determining a control policy for an agent interacting with an environment, the method comprising:
maintaining data defining a plurality of information sets, each information set corresponding to a respective set of policy constraints and identifying Q values assigned to observation—action pairs by the control policy under the set of policy constraints;
receiving a current observation characterizing a current state of the environment, a current action performed by the agent in response to the current observation in accordance with a current control policy, and a reward received as a result of the agent performing the current action;
determining a policy-consistent backup for the control policy at the current observation—current action pair, comprising:
for each of a plurality of next states:
for each of a plurality of actions in a set of possible actions that can be performed by the agent, identifying Q values assigned by the control policy to next observation—action pairs by the control policy and justified by at least one of the information sets, wherein the next observation is an observation that characterizes the next state; and
pruning, from the identified Q values, any Q values that are justified only by information sets that are not policy-class consistent; and
determining, from the reward and only the identified Q values that were not pruned for each of the next states, the policy-consistent backup; and
updating the control policy for the agent using the policy-consistent backup using Q learning.

7. The method of claim 6, further comprising maintaining a transition model of the dynamics of the environment, wherein determining, from the reward and only the identified Q values that were not pruned, the policy-consistent backup comprises determining a Bellman backup using the reward and the identified Q values that were not pruned for the next states.

8. The method of claim 7, wherein the transition model maps the current observation and the current action to a respective probability for each of the next states, and wherein determining the Bellman backup comprises determining a Bellman backup using the reward, the respective probabilities for the next states, and the identified Q values that were not pruned for the next states.

9. The method of claim 6, wherein the control policy selects actions to be performed by the agent using a neural network, and wherein updating the control policy comprises training a respective neural network for each information set that justifies a Q value that was not pruned.

10. The method of claim 6, wherein the control policy selects actions to be performed by the agent using a linear function approximator, and wherein updating the control policy comprises updating weights of a respective linear function approximator for each information set that justifies a Q value that was not pruned.

11. The method of claim 6, wherein the control policy selects actions to be performed by the agent using a tabular representation that maps observation—action pairs to Q values, and wherein updating the control policy comprises updating the Q value for the current observation—action pair in a respective tabular representation for each information set that justifies a Q value that was not pruned.

12. The method of claim 6, wherein:
the agent comprises a mechanical agent;
the observation characterizing the current and/or next state of the environment comprises or is generated from sensor data;
the current action and/or set of possible actions comprises inputs to control the mechanical agent.

13. The method of claim 6, wherein:
the agent comprises an electronic agent;
the observation characterizing the current and/or next state of the environment comprises or is generated from sensor data monitoring part of a plant or service facility;
the current action and/or set of possible actions comprises actions controlling and/or imposing operating conditions on items of equipment in the plant or service facility.

14. (canceled)

15. A system comprising one or more computers and one or more storage devices storing instructions that when executed by one or more computers cause the one or more computers to perform operations comprising:
maintaining data defining a plurality of information sets, each information set corresponding to a respective set of policy constraints and identifying Q values assigned to observation—action pairs by the control policy under the set of policy constraints;
receiving a current observation characterizing a current state of the environment, a current action performed by the agent in response to the current observation, a next observation characterizing a next state of the environment, and a reward received as a result of the agent performing the current action;
determining a policy-consistent backup for the control policy at the current observation—current action pair, comprising:
for each of a plurality of actions in a set of possible actions that can be performed by the agent, identifying Q values assigned by the control policy to next observation —action pairs by the control policy and justified by at least one of the information sets;
pruning, from the identified Q values, any Q values that are justified only by information sets that are not policy-class consistent; and
determining, from the reward and only the identified Q values that were not pruned, the policy-consistent backup; and
updating the control policy for the agent using the policy-consistent backup using Q learning.

16. The system of claim 15, wherein updating the control policy for the agent using the policy-consistent backup using Q learning comprises updating the control policy using model-free Q learning, and wherein determining, from the reward and only the identified Q values that were not pruned, the policy-consistent backup comprises determining a Q-backup.

17. The system of claim 15, wherein the policy-consistent backup includes a respective backup for each information set that justifies a Q value that was not pruned.

18. The system of claim 17, wherein the respective backup is based on (i) the reward and (ii) the Q value that was not pruned and that is justified by the information set.

19. The system of claim 15, wherein information sets that are not policy-class consistent are those information sets that impose policy constraints that result in the control policy not selecting the current action in response to the current observation.
